(19) United States
(12) Patent Application Publication
(10) Pub. No.: US 2024/0113438 A1
(43) Pub. Date: Apr. 4, 2024

(54) PACKAGE INTEGRATED MULTIBAND AND POLARIZATION DIVERSIFIED MODE RECONFIGURABLE ANTENNA SYSTEM FOR ROBUST WIRELESS CHIP TO CHIP COMMUNICATION

(71) Applicant: Intel Corporation, Santa Clara, CA (US)

(72) Inventors: Zhen ZHOU, Chandler, AZ (US); Shuhei YAMADA, Hillsboro, OR (US); Renzhi LIU, Portland, OR (US); Tae Young YANG, Portland, OR (US); Tolga ACIKALIN, San Jose, CA (US); Kenneth P. FOUST, Beaverton, OR (US)

(21) Appl. No.: 17/955,551

(22) Filed: Sep. 29, 2022

(51) Int. Cl. H01Q 9/16

(52) U.S. Cl. CPC H01Q 9/16

(57) ABSTRACT

A package-to-package communication system is provided including a first package having integrated on a first substrate a first antenna, a second antenna, and a first transceiver coupled to the first antenna and the second antenna. The first antenna is arranged along a first edge of the first substrate. The second antenna is arranged along a second edge of the first substrate. A second package having integrated on a second substrate a third antenna, a fourth antenna and a second transceiver coupled to the third antenna and the fourth antenna. The third antenna is arranged along a third edge of the second substrate. The fourth antenna is arranged along a fourth edge of the second substrate. The first antenna and the third antenna are configured to communicate signals of a vertical polarization. The second antenna and the fourth antenna are configured to communicate signals of a horizontal polarization.

### TECHNICAL FIELD

The present disclosure relates to contactless package-to-package communication systems and antenna structures for wireless package-to-package communications.

### BACKGROUND

Achieving higher aggregated data rate and robust wireless communication within ultra-wide band (UWB) can be very challenging, especially if an available area for antenna replacements is limited and hence high isolation among antennas is hard to achieve even with frequency diversity and polarization diversity. In addition, the bandwidth may inherently be limited due to the operational frequency range of UWB, which consequently further limits the achievable aggregated data rate. Current package-to-package communication uses multiple antennas operating with the same frequency band with a very large space separation, multiple antennas with frequency diversity, or dual polarization antennas. However, these solutions require a large antenna area; have a poor isolation of antennas, and/or require a complicated antenna feeding network.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic top view of a package-to-package communication system;

FIGS. 2A to 2C show schematic perspective illustrations of the packages in the package-to-package communication system;

FIGS. 3A to 3C show illustrations of various signal transmission modes in the package-to-package communication system;

FIG. 4 illustrates a schematic illustration of a package-to-package communication system;

FIG. 5 illustrates a schematic illustration of a package-to-package communication system;

FIG. 6A to 6C show schematic perspective illustrations of a package in the package-to-package communication system;

FIGS. 7A to 7F show illustrations of the vertically polarized antenna in the package-to-package communication system;

FIGS. 8A to 8C show illustrations of a horizontally polarized antenna in a package-to-package communication system; and

FIG. 9A to 9D show antenna elements of an antenna in a package-to-package communication system.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

The antenna structures for wireless package-to-package communications provide a solution which engages two multiband antennas integrated within packages to provide antenna diversity and achieve higher aggregated data rate and, thus, overcomes the data rate bottleneck imposed by the limited available area for antenna placements.

As an example, transmitting the same data stream through two multiband antennas placed at opposing edges of a package with antenna diversity, e.g. one horizontally (H-plane) polarized antenna and one vertically (V-plane) polarized antenna, mitigates multipath fading, and provides user interference for robust communication and higher aggregated data rate. Thus, in the wireless package-to-package communication system, the isolation between two antennas becomes less important, and hence the antennas' system size can be compact. This way, wireless package-to-package communication system improves the channel capacity by transmitting data on different carrier frequencies. Hence, the communication may be less susceptible to multipath fading and interference.

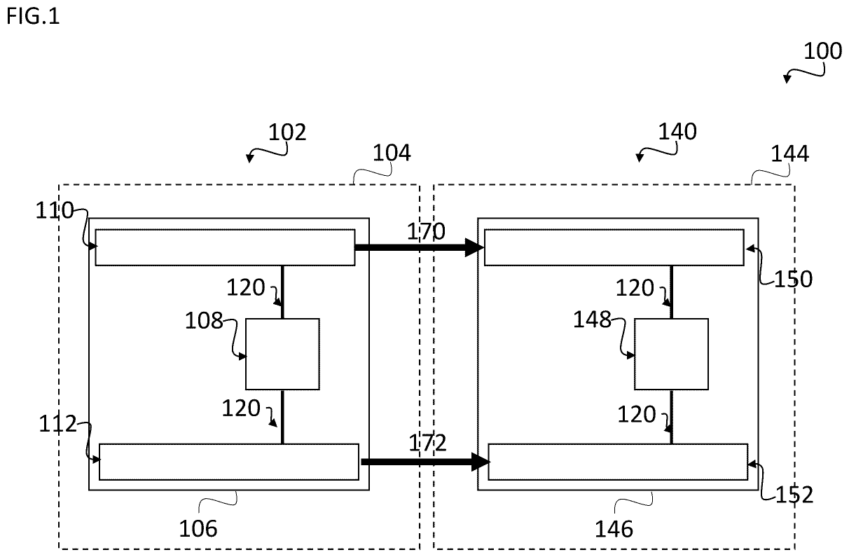

FIG. 1 illustrates a schematic top view of a package-to-package communication system 100. The package-to-package communication system 100 may include a first package 102 having integrated on a first substrate 106 a first antenna 110, a second antenna 112, and a first transceiver 108 coupled to the first antenna 110 and the second antenna 112. The first antenna 110 may be arranged along a first edge of the first substrate 106, and the second antenna 112 may be arranged along a second edge of the first substrate 106.

The first edge and the second edge may be arranged along opposing sides of the first substrate 106. The third antenna 150 and the fourth antenna 152 may be arranged in a common plane of the second substrate 146. The third edge and the fourth edge may be arranged along opposing sides of the second substrate 146. Here, opposing sides may be arranged on or at the same surface side on opposite edges of the substrate, e.g. facing each other in a rectangle. The antennas may be formed in portions of the substrate that are free of functionally active components of the package, e.g. free of logic circuits.

The package-to-package communication system 100 may include a housing structure 104, 144. The first package 102 and the second package 140 may be arranged in the housing structure 104, 144. The housing structure 104, 144 may be separate for each of the first package 102 and the second package 140, or alternatively as a shared housing structure for bot of the first package 102 and the second package 140. An air gap may be between the first package 102 and the second package 140. The first package 102 and the second package 140 may be movable relative to each other. As an example, in a first operation mode, the first package 102 and the second package 140 may be arranged in a common plane. In a second operation mode, the first package 102 and the second package 140 may be arranged in an angle relative to each other.

As an example, a mobile computing device using the package-to-package communication system 100 may include a first device component, a hinge 502 (see FIG. 5), and a second device component. The second device component may be movably attached, e.g. rotatable, to the first device component, e.g. by the hinge. The first device component may include the first package 102 arranged in a first housing structure 104 coupled to a second housing structure 144 housing the second package 140. The first housing structure 104 may be movably attached to the second housing structure 144. As an example, the first device component may include a central processing unit of the device; and the second device component may include a display of the device.

The package-to-package communication system 100 may further include a second package 140 having integrated on a second substrate 146 a third antenna 150, a fourth antenna 152 and a second transceiver 148 coupled to the third antenna 150 and the fourth antenna 152. The third antenna 150 may be arranged along a third edge of the second substrate 146, and the fourth antenna 152 may be arranged along a fourth edge of the second substrate 146. The first antenna 110 and the third antenna 150 may be configured to communicate signals of a vertical polarization (in FIG. 1 illustrated by the upper arrow 170), and the second antenna 112 and the fourth antenna 152 may be configured to communicate signals of a horizontal polarization (in FIG. 1 illustrated by the lower arrow 172).

The first package 102 and the second package 140 may be arranged such that radiation pattern (e.g. a main direction of the radiation pattern) of the first antenna 110 is directed towards the third antenna 150 (also denoted as the first antenna 110 faces the third antenna 150, or the first antenna 110 is side by side to the third antenna 150), and the radiation pattern of the second antenna 112 is directed towards the fourth antenna 152. The first antenna 110 may be configured to have an end-fire radiation pattern along a direction towards the third antenna 150. The third antenna 150 may be configured to have an end-fire radiation pattern along the direction towards the first antenna 110. The second antenna 112 may be configured to have an end-fire radiation pattern along a direction towards the fourth antenna 152. The fourth antenna 152 may be configured to have an end-fire radiation pattern along the direction towards the second antenna 112.

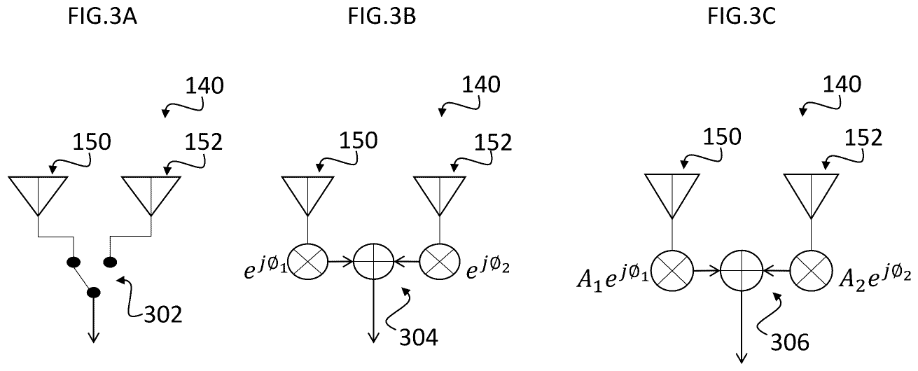

In other words, the first antenna 110 may be configured to transmit a first signal, and the second antenna 112 may be configured to transmit a second signal. The third antenna 150 may be configured to receive the first signal, and the fourth antenna 152 may be configured to receive the second signal. A second transceiver 148 coupled to the third antenna 150 and the fourth antenna 152 through transmission lines 120 may process the first signal and second signal, e.g. may combine the first signal and the second signal, see also FIG. 3A to FIG. 3C. The first antenna 110, the second antenna 112, the third antenna 150, and the fourth antenna 152 may be configured for near field communication. As an example, the first package 102 and the second package 140 may be components of a computing device that are wirelessly communicatively coupled.

The first transceiver 108 may be configured to transmit a single data stream via the first antenna 110 and the second antenna 112, e.g. through a transmission line 120. The single data stream may contain the same content to be transmitted via both antennas 110, 112 of the first package 102, e.g. the same bit sequence. Alternatively, or in addition, the first transceiver 108 may be configured to transmit a first data stream via the first antenna 110 and a second data stream via the second antenna 112. The first data stream may contain to be transmitted via the first antenna 110 may contain a content different from the content to be transmitted via the second antenna 112.

The first antenna 110 and the third antenna 150 may be configured to communicate signals of a first frequency band, and the second antenna 112 and the fourth antenna 152 may be configured to communicate signals of a second frequency band. The first frequency band and the second frequency band may be non-overlapping, as an example. Alternatively, or in addition, at least one of the first antenna 110 and second antenna 112 may be a multiband antenna. At least one of the third antenna 150 and fourth antenna 152 may be a multiband antenna. Alternatively, or in addition, each of the first antenna 110, the second antenna 112, the third antenna 150, and the fourth antenna 152 may be configured to communicate in at least a first frequency band and a second frequency band, wherein the first frequency band and the second frequency band may be non-overlapping.

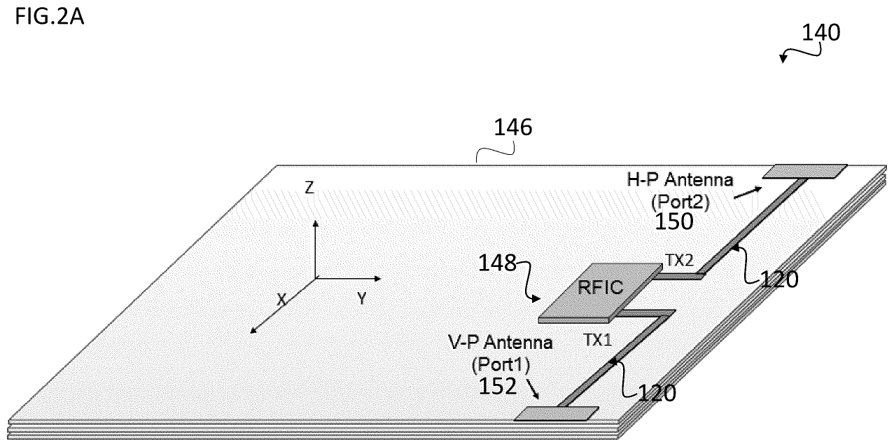

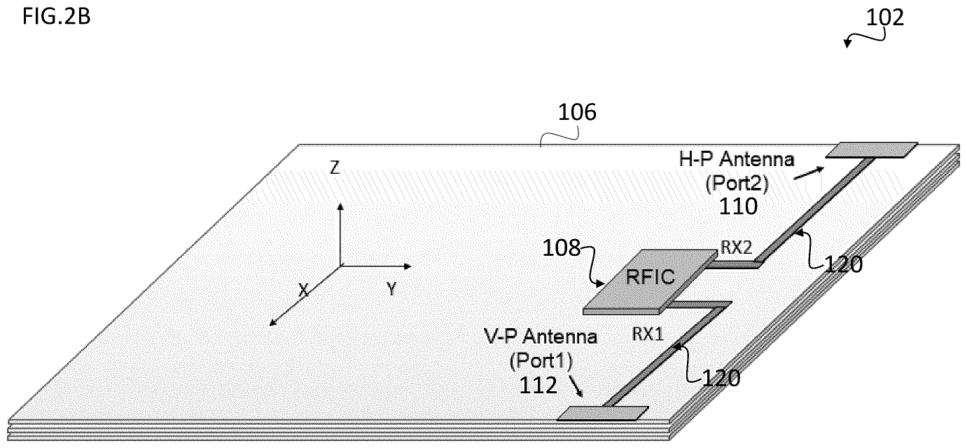

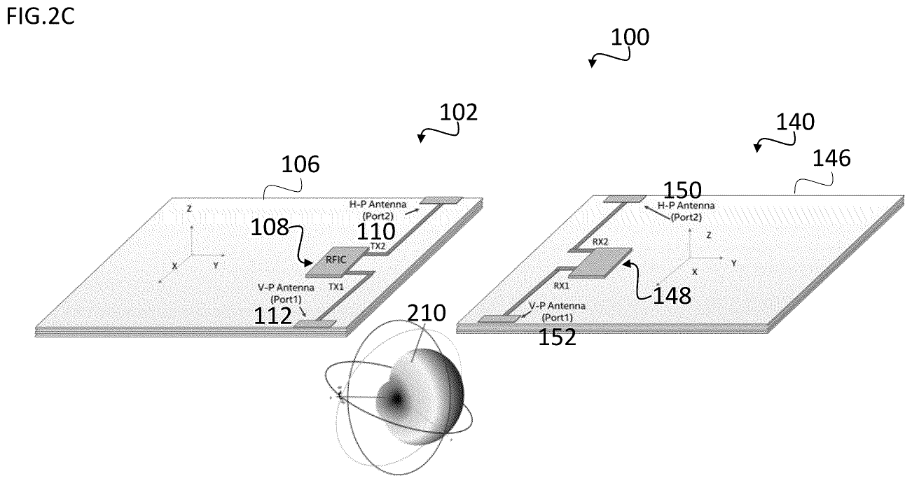

FIG. 2A to FIG. 2C show schematic perspective illustrations of the packages in the package-to-package communication system. The wireless package-to-package communication system may include a package integrated polarization diversity operational mode reconfigurable antenna system. The package integrated polarization diverse operation mode reconfigurable antenna system 100 is illustrated in FIG. 2A to FIG. 2C. In this system 100, the second antenna 112 radiates as a vertically polarized antenna (V-Pol) while the first antenna 110 transmits as a horizontally polarized antenna (H-Pol), as illustrated in FIG. 2A. The second package 140 has the third antenna 150 and the fourth antenna 152 (see FIG. 2B) corresponding to the antennas 110, 112 of the first package, as illustrated in FIG. 2C. The antennas 110, 112, 150, 152 may be configured as end-firing antennas. A radiation pattern 210 of the horizontally polarized second antenna 112 transmitting a signal to the fourth antenna 152 is also illustrated in FIG. 2C. Note that the polarization direction of the first antenna 110 and the second antenna 112 are exchangeable as long as the configuration of the third antenna 150 and the fourth antenna 152 is amended correspondingly. In other words, the first antenna 110 and the third antenna 150 form a first communicating antenna pair, and the second antenna 112 and the fourth antenna 152 form a second communicating antenna pair. Antennas of an antenna pair are configured for the same polarization direction, and are placed side-by-side. This way, the isolation of the antennas of the first package can be improved. Further, signal cross-talk of the first and second communicating antenna pairs can be reduced, and hence data transmission can be improved.

In multipath rich and dynamically changing channel environment, the signal-to-noise ratio (SNR) at the receiver, e.g. the second package 140, changes dynamically which significantly impacts the performance of the system 100. Depending on the channel performance, the system 100 can be configured to operate in different modes, e.g. single data stream mode or dual data stream mode. Multiple receive antenna technique can be used to mitigate such SNR variation. Illustratively, in a single stream mode, identical data stream is carried through both V-Pol and H-Pol channels (see arrows 170, 172 in FIG. 1). This way, signal integrity can be improved.

The second antenna 112 may be configured to have an end-fire radiation pattern along a direction towards the fourth antenna 152. The fourth antenna 152 may be configured to have an end-fire radiation pattern along the direction towards the second antenna 112.

FIG. 3A to FIG. 3C show illustrations of various signal transmission modes in the package-to-package communication system. The received signals by V-pol and H-pol antennas can be combined in three different methods in the receiver end as shown in FIG. 3A to FIG. 3C. The second package 140, e.g. the second transceiver 148 (see FIG. 2B) can be configured to different operational modes, as illustrated in FIG. 3A to FIG. 3C. One operational mode of a plurality of operational modes can be dynamically selected based on the channel performance. This way, the trade-off between the system complicity vs the performance can be balanced.

In particular, a first operational mode, illustrated in FIG. 3A, the second transceiver 148 may select the antenna of the third antenna 150 and the fourth antenna 152 which has a better signal reception. In a second operational mode, illustrated in FIG. 3B, the second transceiver 148 may adjust the phase of signals received by the third antenna 150 and the fourth antenna 152 and combine the received signals to provide a combined signal. The second operational mode can be selected, e.g. in case either one of the third antenna 150 and the fourth antenna 152 has a poor reception that may possibly introduce noise in the signal. In a third operational mode, illustrated in FIG. 3C, the second transceiver 148 may adjust the phase and the amplitude of signals received by the third antenna 150 and the fourth antenna 152 and combine the received signals to provide a combined signal. The third operational mode can be selected to maximize the signal to noise ratio.

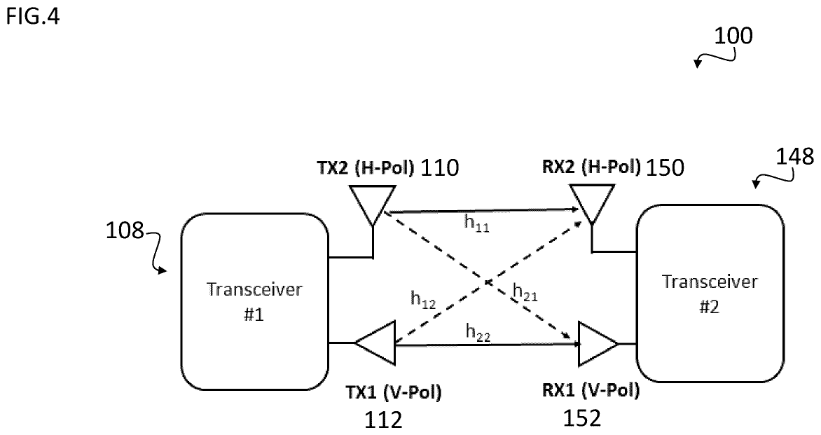

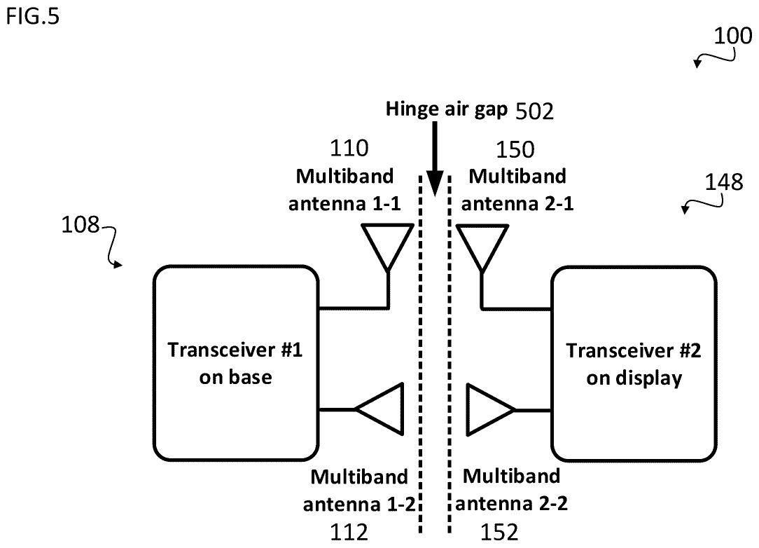

Furthermore, independent data stream can be carried on each polarization received by the third antenna and fourth antenna. Thus, the communication system may form a polarization diversified 2x2 multiple input-multiple output (MIMO), as illustrated in FIG. 4. Thus, the communication system can increase the aggregated data rate. As an example, in case the first antenna 110 and the second antenna 112 provide signals having high enough polarization isolation, there is no crosstalk component (i.e. h₁₂=h₂₁≠0) in the signals received by third antenna 150 and fourth antenna 152. Thus, the communication system 100 may enable two isolated streams, e.g. communication channels h₁₁ and h₂₂) to support multiplexing.

Alternatively, or in addition, the wireless package-to-package communication system 100 may include a package integrated multiband antenna in at least one of V-Pol and H-Pol.

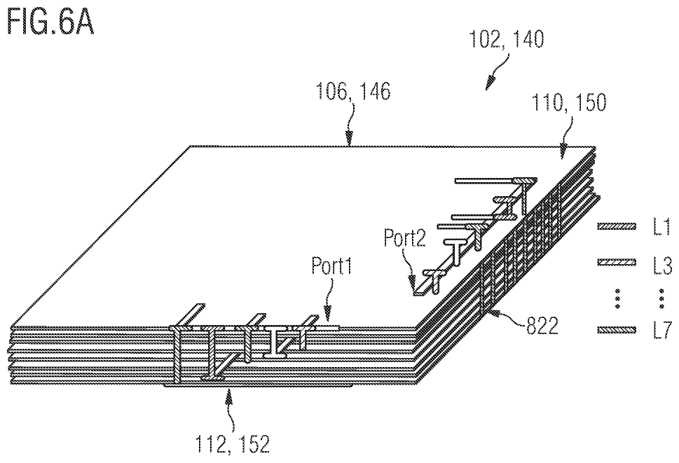

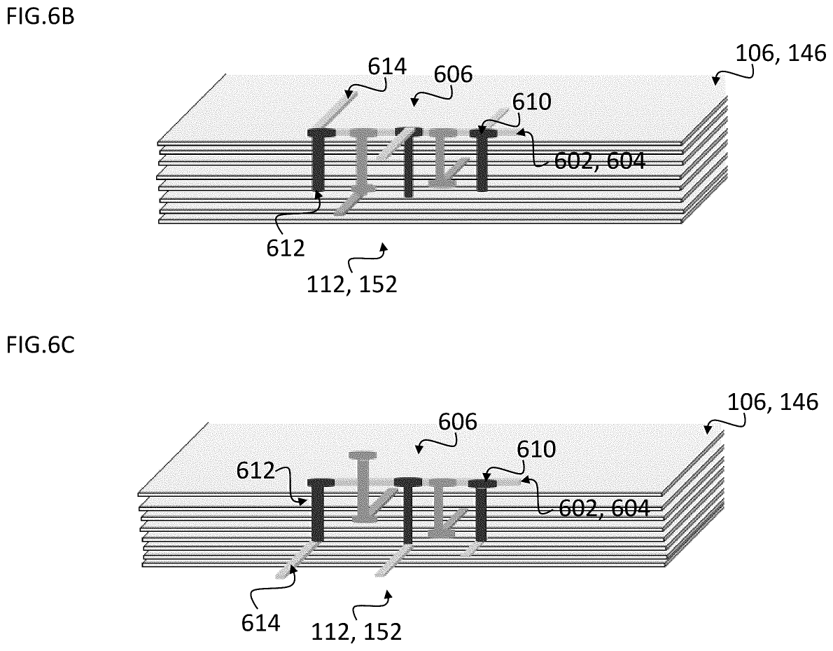

FIG. 6A to FIG. 6C show schematic perspective illustrations of a package in the package-to-package communication system. FIG. 6A illustrates an alternative arrangement of the first/third antenna regarding the second/fourth antenna on the first/second substrate compared to the arrangement illustrated in FIG. 2A. Illustrated in FIG. 6A is a substrate having a first/third antenna 110, 150 along a first edge and a second/fourth antenna 112, 152 along a second edge of a substrate 106, 146. The substrate 106, 146 may be a multi-level substrate (in FIG. 6A illustrated by L1, L3, . . . L7). The antennas may be coupled to the first/second transceiver (not illustrated) of the respective package via a port Port1, Port2. The respective antenna 110, 112, 150, 152 may include a plurality of capacitive antenna elements 606, see FIGS. 6B and 6C. As illustrated in FIG. 6B and FIG. 6C, the antenna 112, 152 may have one of various configurations to provide a signal of one or more desired frequencies or frequency bands, and of a desired radiation pattern, e.g. to enable a desired antenna isolation. The antenna 110, 150 may include a plurality of antenna elements 606. Each antenna element 606 may include a patch 610 coupled to a string 602, 604 through a monopole structure 612, e.g. a via. The patch 610 may be a loading element 610. The substrate 106 may be a multi-layer substrate having a plurality of layers. The antenna elements 606 may be configured as monopole antennas embedded in the substrate 106, 146, respectively.

The capacity of an antenna element may be adjusted by the level of the lower contact, e.g. electrode of the respective capacitor.

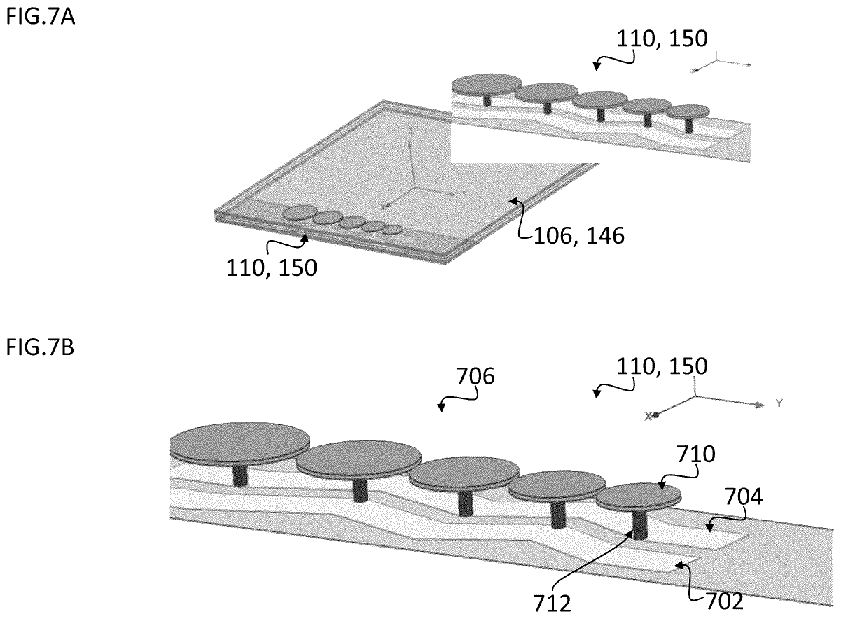

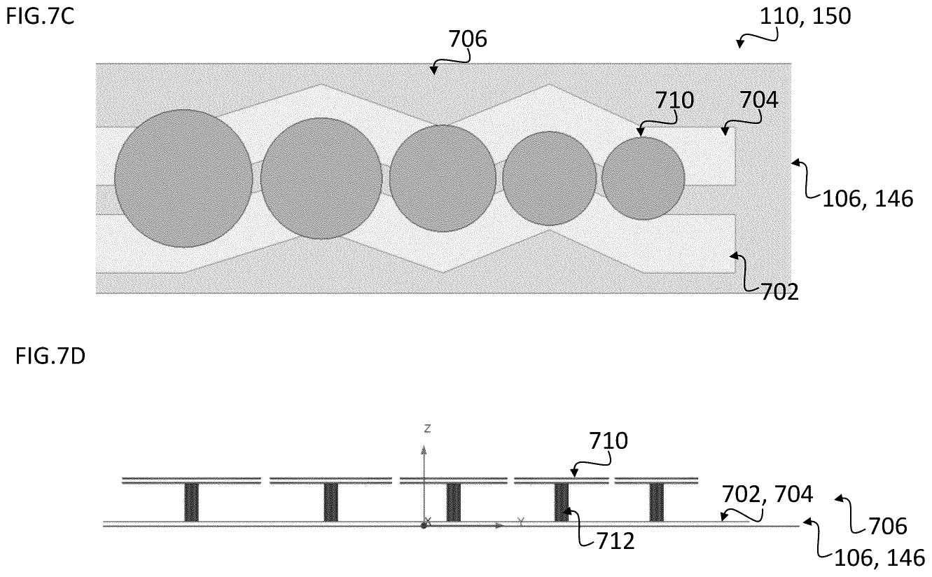

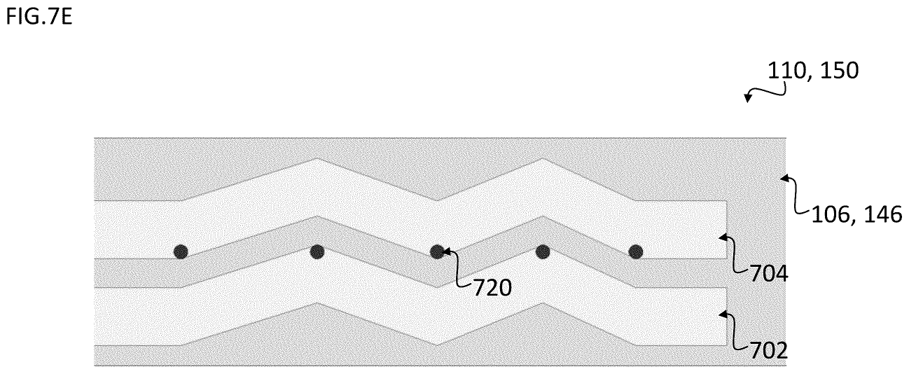

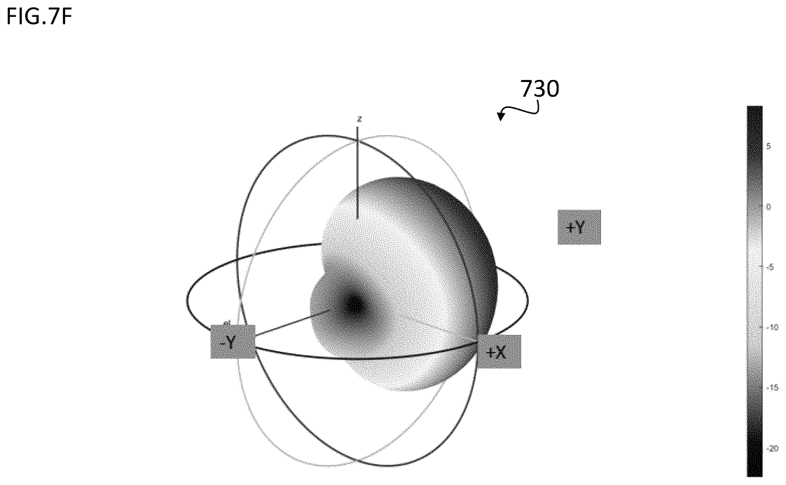

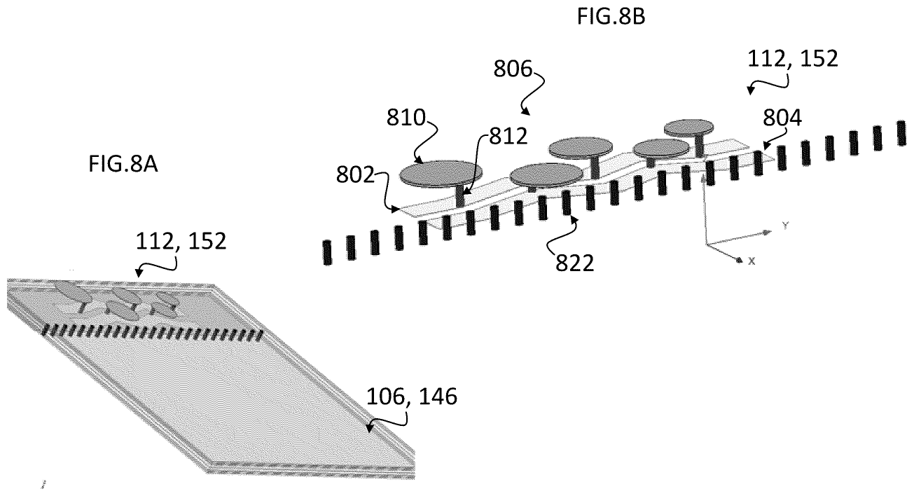

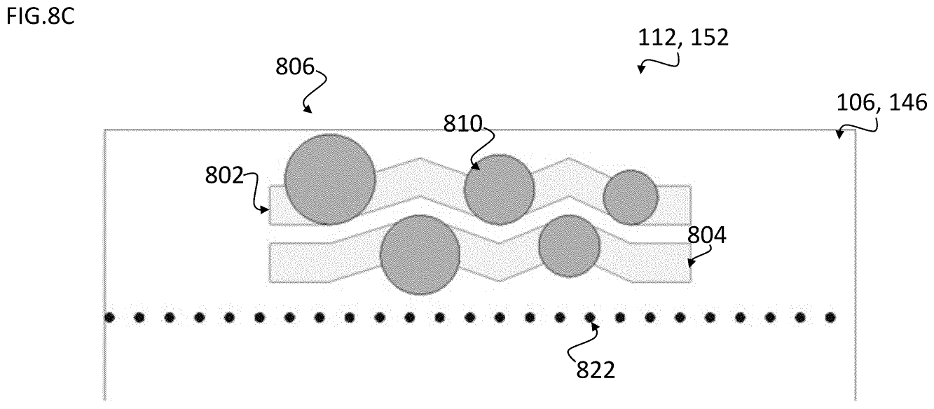

In detail, FIG. 6 illustrates a perspective illustration of the first/third antenna 110, 150 and the second/fourth antenna 112, 152 of the first/second package 102, 140. FIG. 7A to FIG. 7F illustrate an example of vertically polarized antenna, and FIG. 8A to FIG. 8C illustrate an example of a horizontally polarized antenna.

FIG. 7A to FIG. 7F show illustrations of the vertically polarized antenna in the package-to-package communication system. In particular, FIG. 7A illustrates an arrangement of the vertically polarized antenna 106, 146 along an edge of the substrate 106, 146. FIG. 7A also illustrates a zoomed view of the antenna that is described in more detail in FIGS. 7B to 7F. In particular, FIG. 7B illustrates a perspective view of the antenna, FIG. 7C illustrates a top view of the antenna, FIG. 7D illustrates a side view of the antenna, FIG. 7E illustrates a cross-sectional top view of the antenna to illustrate the monopole structure position on the co-planar feeding structures; and FIG. 7F illustrates a radiation pattern of the antenna. A co-planar feeding structure may be or include co-planar feeding strips or co-planar feeding slots for example.

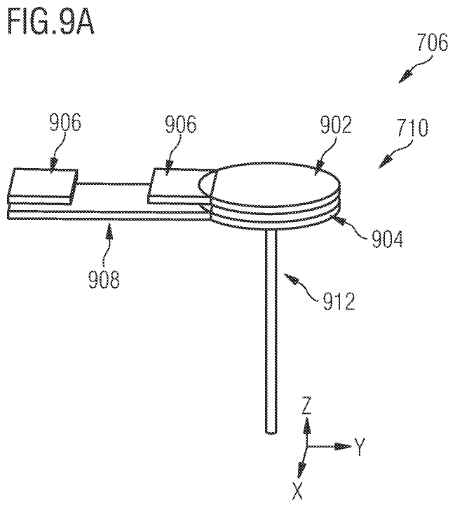

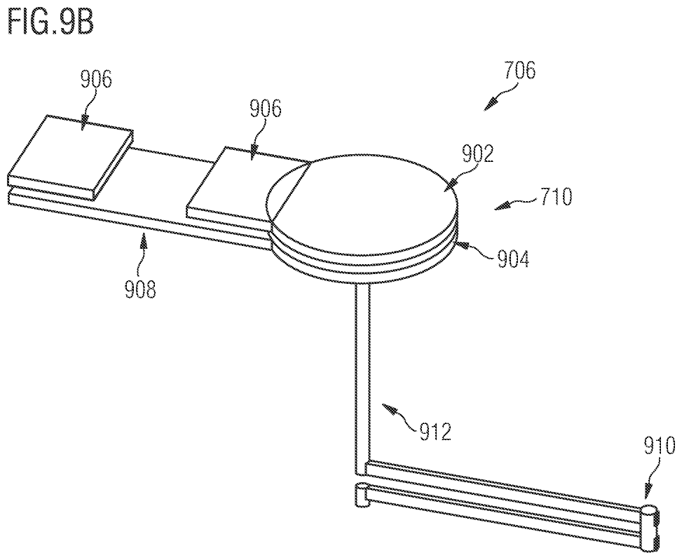

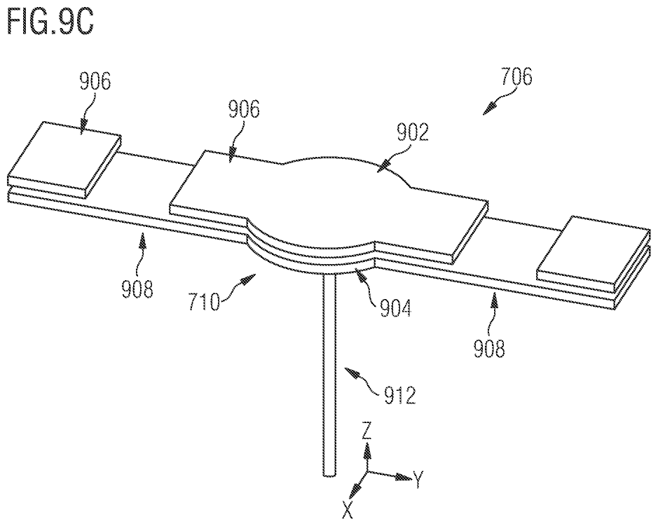

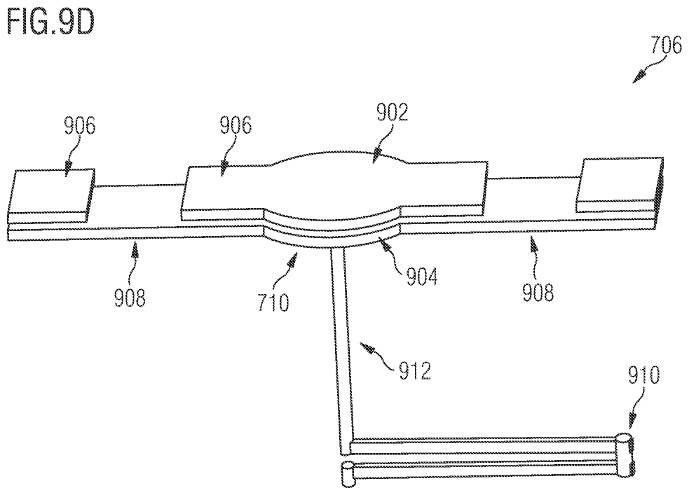

The antenna 110, 150 includes a plurality of antenna elements 706, and two co-planar feeding structures 702, 704, e.g. a first feeding structure 702 and a second feeding structure 704. Each of the antenna elements 706 may include a loading element 710 coupled to one of the co-planar feeding structures 702, 706 through a monopole structure 712. The monopole structure 712 may be a via for example. The monopole structure 712 may be arranged in about a center or symmetry axis of the loading element 710. The monopole structure 712 may be formed by a vertical via (see also FIG. 9A or FIG. 9C) or a meandered via (see also FIG. 9B or FIG. 9D). The main radiating part of the antenna element 706 may be the monopole structure 712. The loading element 710 may include one or more slots or cuts for tuning the resonance frequency (not illustrated). The loading element 710 may be arranged at least in part above both co-planar feeding structures, e.g. covering at least a part of each of the co-planar feeding structures. The positions of monopole structures 720 on the co-planar feeding structures may alternate between the first feeding structure 702 and the second feeding structure 704, as illustrated in FIG. 7E. As an example, the co-planar feeding structures 702, 704 may be formed such that the antenna elements 706 are fed alternating by the feeding structures 702, 704. This way, the antenna may be an end-fire antenna allowing an improved isolation of the antenna signal, as illustrated by the radiation pattern 730 in FIG. 7F.

Illustratively and in other words, the vertically polarized antenna 110, 150 may use a package multilayer stack-up to form a capacitively loaded or inductively loaded monopole log-periodic antenna (CL-MPLPA/IL-MPLPA). The CL-MPLPA/IL-MPLPA may be placed on a top of the ground plane on the bottom layer of the package 102, 140. As an example, the loading element 710 may be configured on L1 and L2 as planar coil inductors and may have a via to serially load the antenna. Alternatively, or in addition, the loading element 710 may be loaded both capacitively and inductively at the same time. The loading for each of the monopole antenna elements 706 may be realized by the loading elements 710, e.g. a parallel plate capacitor, constructed by the metallic features on the top layer (L1) and an internal layer (L2 for instance) and additional lump element loading structures. The loading is illustrated in more detail in FIG. 9A to FIG. 9D. The shape of the loading elements 710 is illustrated as circular. However, other shapes can be used as well for the loading elements 710. The area of the parallel plate of the loading elements 710 may be controlled by the loading which may require to have the associated monopole antenna to resonant at the desired frequency. The two plates of the loading elements 710 may have identical shapes, as an example only. Also, for each of the loading elements 710, the position of the internal layer can vary depending on the loading capacitance required. The CL-MPLPA is fed through the two co-planar feeding structures 702, 704 placed on an internal layer to touch the monopole. The CL-MPLPA may be configured to have an end-fire radiation pattern 730 along +Y direction as illustrated in FIG. 7F.

In other words, the first antenna 110 may include a plurality of antenna elements 706 respectively coupled to at least one of two co-planar feeding structures 702, 704 on an internal layer of the first substrate 106 close to a bottom layer of the first substrate 106, wherein the plurality of antenna elements 706 may be configured as a capacitively loaded monopole log-periodic antenna (CL-MPLPA) and/or inductively loaded monopole log-periodic antenna (IL-MPLPA). The third antenna 150 may include a plurality of antenna elements 706 respectively coupled to at least one of two co-planar feeding structures 702, 704 on an internal layer of the second substrate 146 close to a bottom layer of the second substrate 146, wherein the plurality of antenna elements may be configured as a capacitively loaded monopole log-periodic antenna (CL-MPLPA) and/or inductively loaded monopole log-periodic antenna (IL-MPLPA).

Each of the antenna elements 706 may include a patch, e.g. the loading elements 710, above at least one feeding structure 702, 704 of the two co-planar feeding structures 702, 704, and wherein a monopole structure 712 coupled to one of the co-planar feeding structures 702, 704 and the loading elements 710 forms electrical monopoles with the loading elements 710. The monopole structure 712 may be respectively arranged in about a center of the loading elements 710. The loading elements 710 may be arranged at least in part above both of the co-planar feeding structures 702, 704 respectively.

FIG. 8A to FIG. 8C show illustrations of the horizontally polarized antenna (H-Pol LPA) in the package-to-package communication system, similar to the vertical polarized antenna illustrated in FIG. 7A to FIG. 7F. FIG. 8A illustrates a perspective view of the H-pol antenna 112, 152 arranged along an edge of the substrate 106, 146, FIG. 8B illustrates a perspective view of components of the H-Pol antenna 112, 152; and FIG. 8C illustrates a top view of the H-Pol antenna 112, 152. The antenna 112, 152 includes a plurality of antenna elements 806, and two co-planar feeding structures 802, 804, e.g. a first feeding structure 802 and a second feeding structure 804. Each of the antenna elements 806 may include a planar element 810 coupled to one of the co-planar feeding structures 802, 806 through a via structure 812 acting as a feeding probe. The feeding probe 812 may be a via for example. The feed probe 812 may be arranged off-center, e.g. eccentric, regarding a center or symmetry axis of the loading element 810. For an H-pol antenna, the loading element 810 may be a planar monopole element, e.g. a planar monopole antenna. Thus, the planar monopole element 810 may include one or more slots or cuts for the purpose of size reduction, e.g. for tuning the resonance frequency (not illustrated). The planar monopole element 810 may be arranged above one of the co-planar feeding structures 802, 804, e.g. covering at least a part of one of the co-planar feeding structures and the other of the co-planar feeding structures 802, 804 remains free from the planar monopole element 810. The positions of feeding probe structures 812 on the co-planar feeding structures may alternate between the first feeding structure 802 and the second feeding structure 804.

Illustratively and in other words, each antenna element 806 of the H-Pol LPA may have a circular patch monopole element 810 and is fed by one of the co-planar feeding structures 802, 804 on an internal layer close to the bottom layer and a feeding probe 812. The shape of the planar monopole element 810 can take different shapes such as circular, elliptical, rectangular, or square. In addition, each patch can have cuts or slots on it to capacitively load the patch for the purpose of size reduction. A plurality of vias 822 arranged adjacent to the antenna elements, e.g. as a via fence, may suppress the radiation of via feeding probe structures to ensure horizontal polarization.

A horizontally polarized antenna for a package-to-package communication system may include a plurality of antenna elements respectively coupled to at least one of two co-planar feeding structures arranged on a substrate. A plurality of vias may be arranged next to the antenna elements in the substrate. The vias may be arranged along the antenna elements. The vias may be electrically floating. The antenna may be configured as a capacitively loaded monopole log-periodic antenna (CL-MPLPA) and/or inductively loaded monopole log-periodic antenna (IL-MPLPA). Each of the antenna elements may include a patch above at least one feeding structure of the two co-planar feeding structures, and wherein a feeding probe coupled to one of the co-planar feeding structures and the patch forms electrical monopoles with a feeding probe such as a via 812. The feeding probe structure may be respectively arranged eccentric/centric to the patch. The patch may be arranged above one of the co-planar feeding structures. At least one patch of the plurality of antenna elements may include at least one cut or slot. The patches of the plurality of antennas have a circular shape, an elliptical shape, a rectangular shape, or a square shape.

In other words, the second antenna 112 may be configured as a capacitively loaded monopole log-periodic antenna (CL-MPLPA) and/or inductively loaded planar monopole log-periodic antenna (IL-MPLPA) having a plurality of antenna elements 806 respectively coupled to at least one of two co-planar feeding structures 802, 804 on an internal layer close to a bottom layer of the first package 102. A plurality of vias 822 (see FIG. 8B) may be arranged next to the antenna elements 806. The fourth antenna 152 may be configured as a capacitively loaded monopole log-periodic antenna (CL-MPLPA) and/or inductively loaded monopole log-periodic antenna (IL-MPLPA) having a plurality of antenna elements 806 respectively coupled to at least one of two co-planar feeding structures 802, 804 on an internal layer close to a bottom layer of the first package 102. A plurality of vias 822 may be arranged next to the antenna elements 806. The vias 822 may be arranged along the antenna elements 806. Each of the antenna elements 806 may include a patch, e.g. the planar monopole element 810, above at least one feeding structure of the two co-planar feeding structures 802, 804. A via structure 812 coupled to one of the co-planar feeding structures 802, 804 and the planar monopole element 810 forms electrical monopoles. The feeding probe 812 may be respectively arranged eccentric to the planar monopole element 810. The planar monopole element 810 may be arranged above one of the co-planar feeding structures 802, 804. At least one planar monopole element 810 of the plurality of antenna elements 806 may include at least one cut or slot (not illustrated) for frequency tuning. The planar monopole elements 810 of the plurality of antennas may have a circular shape, an elliptical shape, a rectangular shape, or a square shape.

FIG. 9A to 9D show antenna elements of an antenna in a package-to-package communication system. As illustrated in FIG. 9A, antenna elements 706 may include a first monopole loading pad 906, e.g. on L1, above a second monopole loading pad 908, e.g. on L2. The loading pads 906, 908 may be configured as a lumped loading element. The loading element 710 may include a first monopole loading cap 902, e.g. on L1, above a second monopole loading cap 904, e.g. on L2. The second monopole loading cap 904 may be coupled to the via 912. The via 912 may be the radiating component in the vertically polarized antenna, e.g. a via-like monopole structure 912. However, in a horizontally polarized antenna, the via 912 may be the feeding probe 912, as described above (see FIG. 8A to 8C). The via 912 may be substantially straight as illustrated in FIG. 9A and FIG. 9C. However, the via 912 may also have a meandered structure, e.g. laterally protruding portions, as illustrated in FIG. 9B and FIG. 9D. As illustrated in FIG. 9A, the monopole loading pads 906, 908 may be arranged on one side of the loading element 710, as illustrated in FIG. 9A and FIG. 9B. However, there may be more than one lumped loading element 906, 908 attached to the loading cap 902, 904 as illustrated in FIG. 9C and FIG. 9D. FIG. 9A to FIG. 9D illustrates an antenna element for a vertically polarized antenna. However, the antenna elements of the horizontally polarized antenna may also be configured as illustrated in FIG. 9A to FIG. 9D and as described in FIG. 8A to FIG. 8C.

In other words, an antenna element 706 for a polarized antenna for a package-to-package communication system includes integrated in a substrate 106, 146 a loading element 710 including a first loading cap 902 and a second loading cap 906 (e.g. on the same layer), a via-monopole structure 912 coupled to the second loading cap 908 and extending towards a ground plane of the substrate 106, 146; and a loading pad structure laterally coupled to the loading element 710, wherein the loading pad structure comprises a first loading pad 906 coupled to the first loading cap 902, and a second loading pad 908 coupled to the second loading cap 904. The first loading pad may include at least a first portion, e.g. directly coupled to the first loading cap 902, and a second portion spaced apart from the first portion.

Further, the loading pad structure may be a first loading pad structure, and the antenna element 706 may further include a second loading pad structure laterally coupled to the loading element 706, wherein the second loading pad structure includes a third loading pad coupled to the first loading cap, and a fourth loading pad coupled to the second loading cap, as illustrated in FIG. 9C and FIG. 9D.

In the following, various aspects of the present disclosure will be illustrated:

Example 1 is a package-to-package communication system, including a first package having integrated on a first substrate a first antenna, a second antenna, and a first transceiver coupled to the first antenna and the second antenna; wherein the first antenna is arranged along a first edge of the first substrate, and the second antenna is arranged along a second edge of the first substrate, and a second package having integrated on a second substrate a third antenna, a fourth antenna and a second transceiver coupled to the third antenna and the fourth antenna, wherein the third antenna is arranged along a third edge of the second substrate, and the fourth antenna is arranged along a fourth edge of the second substrate. The first antenna and the third antenna are configured to communicate signals of a vertical polarization, and the second antenna and the fourth antenna are configured to communicate signals of a horizontal polarization.

In Example 2, the subject matter of Example 1 can optionally include that the first transceiver is configured to transmit a single data stream via the first antenna and the second antenna.

In Example 3, the subject matter of Example 1 or 2 can optionally include that the first transceiver is configured to transmit a first data stream via the first antenna and a second data stream via the second antenna.

In Example 4, the subject matter of any one of Examples 1 to 3 can optionally include that the first antenna and the third antenna are configured to communicate signals of a first frequency band, and the second antenna and the fourth antenna are configured to communicate signals of a second frequency band, wherein the first frequency band and the second frequency band are non-overlapping.

In Example 5, the subject matter of any one of Examples 1 to 4 can optionally include that the first antenna, the second antenna, the third antenna, and the fourth antenna are configured for near field communication.

In Example 6, the subject matter of any one of Examples 1 to 5 can optionally include that the first antenna is configured to transmit a first signal, and the second antenna is configured to transmit a second signal, and wherein the third antenna is configured to receive the first signal, and the fourth antenna is configured to receive the second signal.

In Example 7, the subject matter of any one of Examples 1 to 6 can optionally include that the first package and the second package are arranged that the first antenna is side-by-side to the third antenna, and the second antenna is side-by-side to the fourth antenna.

In Example 8, the subject matter of any one of Examples 1 to 7 can optionally include that an air gap is arranged between the first package and the second package.

In Example 9, the subject matter of any one of Examples 1 to 8 can optionally include that the first antenna and the second antenna are arranged in a common plane of the first substrate.

In Example 10, the subject matter of any one of Examples 1 to 9 can optionally include that the first edge and the second edge are arranged along opposing sides of the first substrate.

In Example 11, the subject matter of any one of Examples 1 to 10 can optionally include that the third antenna and the fourth antenna are arranged in a common plane of the second substrate.

In Example 12, the subject matter of any one of Examples 1 to 11 can optionally include that the third edge and the fourth edge are arranged along opposing sides of the second substrate.

In Example 13, the subject matter of any one of Examples 1 to 12 can optionally include that at least one of the first antenna and second antenna is a multiband antenna.

In Example 14, the subject matter of any one of Examples 1 to 13 can optionally include that at least one of the third antenna and fourth antenna is a multiband antenna.

In Example 15, the subject matter of any one of Examples 1 to 14 can optionally include that each of the first antenna, the second antenna, the third antenna, and the fourth antenna is configured to communicate in at least a first frequency band and a second frequency band, wherein the first frequency band and the second frequency band are non-overlapping.

In Example 16, the subject matter of any one of Examples 1 to 15 can optionally further include a housing structure wherein the first package and the second package are arranged in the housing structure.

In Example 17, the subject matter of any one of Examples 1 to 16 can optionally include that the first antenna is configured to have an end-fire radiation pattern along a direction towards the third antenna.

In Example 18, the subject matter of any one of Examples 1 to 17 can optionally include that the third antenna is configured to have an end-fire radiation pattern along the direction towards the first antenna.

In Example 19, the subject matter of any one of Examples 1 to 18 can optionally include that the first antenna includes a plurality of antenna elements respectively coupled to at least one of two co-planar feeding structures on an internal layer of the first substrate close to a bottom layer of the first substrate, wherein the plurality of antenna elements is configured as a capacitively loaded monopole log-periodic antenna (CL-MPLPA) and/or inductively loaded monopole log-periodic antenna (IL-MPLPA).

In Example 20, the subject matter of any one of Examples 1 to 19 can optionally include that the third antenna includes a plurality of antenna elements respectively coupled to at least one of two co-planar feeding structures on an internal layer of the second substrate close to a bottom layer of the second substrate, wherein the plurality of antenna elements is configured as a capacitively loaded monopole log-periodic antenna (CL-MPLPA) and/or inductively loaded monopole log-periodic antenna (IL-MPLPA).

In Example 21, the subject matter of any one of Examples 19 to 20 can optionally include that each of the antenna elements includes a patch above at least one feeding structure of the two co-planar feeding structures, and wherein a monopole structure coupled to one of the co-planar feeding structures and the patch forms electrical monopoles with the patch.

In Example 22, the subject matter of Example 21 can optionally include that the monopole structure is respectively arranged in about a center of the patch.

In Example 23, the subject matter of any one of Examples 21 to 22 can optionally include that the patch is arranged at least in part above both of the co-planar feeding structures respectively.

In Example 24, the subject matter of any one of Examples 1 to 23 can optionally include that the second antenna is configured as a capacitively loaded monopole log-periodic antenna (CL-MPLPA) and/or inductively loaded monopole log-periodic antenna (IL-MPLPA) having a plurality of antenna elements respectively coupled to at least one of two co-planar feeding structures on an internal layer close to a bottom layer of the first package, and wherein a plurality of vias is arranged next to the antenna elements.

In Example 25, the subject matter of any one of Examples 1 to 24 can optionally include that the fourth antenna is configured as a capacitively loaded monopole log-periodic antenna (CL-MPLPA) and/or inductively loaded monopole log-periodic antenna (IL-MPLPA) having a plurality of antenna elements respectively coupled to at least one of two co-planar feeding structures on an internal layer close to a bottom layer of the first package, and wherein a plurality of vias is arranged next to the antenna elements.

In Example 26, the subject matter of any one of Examples 24 to 25 can optionally include that the vias are arranged along the antenna elements.

In Example 27, the subject matter of any one of Examples 24 to 26 can optionally include that each of the antenna elements includes a patch above at least one feeding structure of the two co-planar feeding structures, and wherein a monopole structure coupled to one of the co-planar feeding structures and the patch forms electrical monopoles with the patch.

In Example 28, the subject matter of any one of Examples 24 to 27 can optionally include that the monopole structure/feeding probe structure is respectively arranged eccentric to the patch.

In Example 29, the subject matter of any one of Examples 24 to 28 can optionally include that the patch is arranged above one of the co-planar feeding structures.

In Example 30, the subject matter of any one of Examples 19 to 29 can optionally include that at least one patch of the plurality of antenna elements includes at least one cut or slot.

In Example 31, the subject matter of any one of Examples 19 to 30 can optionally include that the patches of the plurality of antennas have a circular shape, an elliptical shape, a rectangular shape, or a square shape.

Example 32 is a mobile computing device, including a first device component, a hinge, and a second device component, wherein the second device component is movably attached to the first device component by the hinge. The first device component includes a first package having integrated on a first substrate a first antenna, a second antenna, and a first transceiver coupled to the first antenna and the second antenna; wherein the first antenna is arranged along a first edge of the first substrate, and the second antenna is arranged along a second edge of the first substrate. The second device component including a second package having integrated on a second substrate a third antenna, a fourth antenna and a second transceiver coupled to the third antenna and the fourth antenna, wherein the third antenna is arranged along a third edge of the second substrate, and the fourth antenna is arranged along a fourth edge of the second substrate. The first antenna and the third antenna are configured to communicate signals of a vertical polarization, and the second antenna and the fourth antenna are configured to communicate signals of a horizontal polarization.

In Example 33, the subject matter of Example 32 can optionally include that the first device component includes a central processing unit of the device; and the second device component includes a display of the device.

In Example 34, the subject matter of Example 32 or 33 can optionally include that the first package and/or the second package is configured according to any one of Examples 1 to 31.

Example 35 is a horizontally polarized antenna for a package-to-package communication system, the antenna including a plurality of antenna elements respectively coupled to at least one of two co-planar feeding structures arranged on a substrate. A plurality of vias is arranged next to the antenna elements in the substrate. The vias are arranged along the antenna elements.

In Example 36, the subject matter of Example 35 can optionally include that the vias are electrically floating.

In Example 37, the subject matter of Example 36 can optionally include that the antenna is configured as a capacitively loaded monopole log-periodic antenna (CL-MPLPA) and/or inductively loaded monopole log-periodic antenna (IL-MPLPA).

In Example 38, the subject matter of any one of Examples 35 to 37 can optionally include that each of the antenna elements includes a patch above at least one feeding structure of the two co-planar feeding structures, and wherein a monopole structure/feeding probe coupled to one of the co-planar feeding structures and the patch forms electrical monopoles with the patch.

In Example 39, the subject matter of any one of Examples 35 to 38 can optionally include that the monopole structure/feeding probe is respectively arranged eccentric to the patch.

In Example 40, the subject matter of any one of Examples 35 to 39 can optionally include that the patch is arranged above one of the co-planar feeding structures.

In Example 41, the subject matter of any one of Examples 35 to 40 can optionally include that at least one patch of the plurality of antenna elements includes at least one cut or slot.

In Example 42, the subject matter of any one of Examples 35 to 41 can optionally include that the patches of the plurality of antennas have a circular shape, an elliptical shape, a rectangular shape, or a square shape.

Example 43 is an antenna element for a polarized antenna for a package-to-package communication system. The antenna element includes integrated in a substrate a loading element including a first loading cap above a second loading cap, a via-monopole structure coupled to the second loading cap and extending towards a ground plane of the substrate; and a loading pad structure laterally coupled to the loading element, wherein the loading pad structure comprises a first loading pad coupled to the first loading cap, and a second loading pad coupled to the second loading cap.

In Example 44, the subject matter of Example 43 can optionally include that the first loading pad includes at least a first portion and a second portion spaced apart from the first portion.

In Example 45, the subject matter of Example 43 or 44 can optionally include that the loading pad structure is a first loading pad structure, and the antenna element further includes a second loading pad structure laterally coupled to the loading element, wherein the second loading pad structure includes a third loading pad coupled to the first loading cap, and a fourth loading pad coupled to the second loading cap.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A package-to-package communication system, comprising:
a first package having integrated on a first substrate a first antenna, a second antenna, and a first transceiver coupled to the first antenna and the second antenna; wherein the first antenna is arranged along a first edge of the first substrate, and the second antenna is arranged along a second edge of the first substrate, and
a second package having integrated on a second substrate a third antenna, a fourth antenna and a second transceiver coupled to the third antenna and the fourth antenna, wherein the third antenna is arranged along a third edge of the second substrate, and the fourth antenna is arranged along a fourth edge of the second substrate; and
wherein the first antenna and the third antenna are configured to communicate signals of a vertical polarization, and the second antenna and the fourth antenna are configured to communicate signals of a horizontal polarization.

2. The communication system according to claim 1, wherein the first transceiver is configured to transmit a single data stream via the first antenna and the second antenna.

3. The communication system according to claim 1, wherein the first transceiver is configured to transmit a first data stream via the first antenna and a second data stream via the second antenna.

4. The communication system according to claim 1, wherein the first antenna and the third antenna are configured to communicate signals of a first frequency band, and the second antenna and the fourth antenna are configured to communicate signals of a second frequency band, wherein the first frequency band and the second frequency band are non-overlapping.

5. The communication system according to claim 1, wherein the first package and the second package are arranged that a radiation pattern of the first antenna is directed towards the third antenna, and a radiation pattern of the second antenna is directed towards the fourth antenna.

6. The communication system according to claim 1, wherein an air gap is arranged between the first package and the second package.

7. The communication system according to claim 1, wherein the first antenna and the second antenna are arranged in a common plane of the first substrate.

8. The communication system according to claim 1, wherein the first edge and the second edge are arranged along opposing sides of the first substrate.

9. The communication system according to claim 1, wherein the third antenna and the fourth antenna are arranged in a common plane of the second substrate.

10. The communication system according to claim 1, wherein the third edge and the fourth edge are arranged along opposing sides of the second substrate.

11. The communication system according to claim 1, wherein at least one of the first antenna, the second antenna, the third antenna, and the fourth antenna is a multiband antenna.

12. The communication system according to claim 1, wherein the first antenna comprises a plurality of antenna elements respectively coupled to at least one of two co-planar feeding structures on an internal layer of the first substrate close to a bottom layer of the first substrate, wherein the plurality of antenna elements is configured as a capacitively loaded monopole log-periodic antenna (CL-MPLPA) and/or inductively loaded monopole log-periodic antenna (IL-MPLPA).

13. The communication system according to claim 1, wherein the second antenna is configured as a capacitively loaded monopole log-periodic antenna (CL-MPLPA) and/or inductively loaded monopole log-periodic antenna (IL-MPLPA) having a plurality of antenna elements respectively coupled to at least one of two co-planar feeding structures on an internal layer close to a bottom layer of the first package, and wherein a plurality of vias is arranged next to the antenna elements.

14. A mobile computing device, comprising a first device component, a hinge, and a second device component, wherein the second device component is movably attached to the first device component by the hinge;
the first device component comprising a first package having integrated on a first substrate a first antenna, a second antenna, and a first transceiver coupled to the first antenna and the second antenna; wherein the first antenna is arranged along a first edge of the first substrate, and the second antenna is arranged along a second edge of the first substrate, and the second device component comprising a second package having integrated on a second substrate a third antenna, a fourth antenna and a second transceiver coupled to the third antenna and the fourth antenna, wherein the third antenna is arranged along a third edge of the second substrate, and the fourth antenna is arranged along a fourth edge of the second substrate; and
wherein the first antenna and the third antenna are configured to communicate signals of a vertical polarization, and the second antenna and the fourth antenna are configured to communicate signals of a horizontal polarization.

15. The mobile computing device of claim 14, wherein the first device component comprises a central processing unit of the device; and the second device component comprises a display of the device.

16. A horizontally polarized antenna for a package-to-package communication system, the antenna comprising a plurality of antenna elements respectively coupled to at least one of two co-planar arranged on a substrate, and wherein a plurality of vias is arranged next to the antenna elements in the substrate, wherein the vias are arranged along the antenna elements.

17. The antenna according to claim 16, wherein each of the antenna elements comprises a patch above at least one feeding structure of the two co-planar feeding structures, and wherein a monopole structure coupled to one of the co-planar feeding structures and the patch forms electrical monopoles with the patch.

18. The antenna according to claim 17, wherein the monopole structure is respectively arranged eccentric to the patch.

19. The antenna according to claim 17, wherein the patch is arranged above one of the co-planar feeding structures.

20. An antenna element for polarized antenna for a package-to-package communication system, the antenna element comprising integrated in a substrate a loading element comprising a first loading cap above a second loading cap,
a via-monopole structure coupled to the second loading cap and extending towards a ground plane of the substrate; and
a loading pad structure laterally coupled to the loading element, wherein the loading pad structure comprises a first loading pad coupled to the first loading cap, and a second loading pad coupled to the second loading cap.

21. The antenna of claim 20,
wherein the first loading pad comprises at least a first portion and a second portion spaced apart from the first portion.

22. The antenna of claim 20,
wherein the loading pad structure is a first loading pad structure, and the antenna element further comprises a second loading pad structure laterally coupled to the loading element, wherein the second loading pad structure comprises a third loading pad coupled to the first loading cap, and a fourth loading pad coupled to the second loading cap.
